(19) United States
(12) Patent Application Publication
(10) Pub. No.: US 2013/0252048 A1
(43) Pub. Date: Sep. 26, 2013

(54) BATTERY AND ASSEMBLY METHOD THEREOF

(71) Applicant: KABUSHIKI KAISHA TOSHIBA, Tokyo (JP)

(72) Inventors: Ryuuichi TERAMOTO, Kanagawa (JP); Hideo SHIMIZU, Nagano (JP); Noboru KOIKE, Nagano (JP); Tadashi SHUDO, Saitama (JP); Nobumitsu TADA, Tokyo (JP); Satoshi WADA, Tokyo (JP); Takahiro TERADA, Kanagawa (JP); Kuniaki YAMAMOTO, Kanagawa (JP)

(73) Assignee: Kabushiki Kaisha Toshiba, Tokyo (JP)

(21) Appl. No.: 13/849,437

(22) Filed: Mar. 22, 2013

(30) Foreign Application Priority Data
Mar. 22, 2012 (JP) 2012-066062

(51) Int. Cl. H01M 2/26

(52) U.S. Cl. CPC H01M 2/266
USPC 429/90; 429/161; 29/623.1; 29/623.2

(57) ABSTRACT

A battery includes a plurality of electrode members each having a positive electrode, a negative electrode and an insulating separator arranged between the positive electrode and the negative electrode, bus bars each electrically connected to electrode members, and a battery case that houses the electrode members.

### CROSS-REFERENCE TO RELATED APPLICATION

This application is based upon and claims the benefit of priority from Japanese Patent Application No. 2012-066062, filed Mar. 22, 2012; the entire contents of which are incorporated herein by reference.

### FIELD

Embodiments described herein relate to a battery and a manufacturing method thereof.

### BACKGROUND

In recent years, rechargeable batteries have been widely used as power sources in electric cars, hybrid electric cars, power-assisted bicycles, and electric equipment. For instance, lithium ion rechargeable batteries, which are non-aqueous rechargeable batteries, have been used as a power source in electric cars because they have high output and high energy density.

A rechargeable battery is typically composed of an outer container made of aluminum (or similar metal) that is in the form of flat rectangular box. The battery has an electrode group housed together with an electrolytic solution in the outer container and electrode terminals, which are connected to the electrode group and set in the outer container.

In addition, in order to attain high capacity and high output, a rechargeable battery may consist of a plurality of cells arranged in a case or box. The plurality of cells may be connected in parallel or in a series to create a battery set. The terminals of the individual cells may be attached to bus bars or electric circuits that connect cells adjacent to the outer surface of the battery set.

In the battery set, the processes of assembling the plurality of cells and electrically connecting plural leads, terminals and bus bars are complicated.

### DESCRIPTION OF THE DRAWINGS

FIG. 1 is a perspective view showing the external appearance of a rechargeable battery device according to an embodiment.

FIG. 2 is a perspective view showing the internal structure of the rechargeable battery device.

FIG. 3 is a perspective view showing the composition of electrode group of the rechargeable battery device.

FIG. 4 is a perspective view showing the upper side of bus bar of the rechargeable battery device.

FIG. 5 is a perspective view showing the bottom side of bus bar of the rechargeable battery device.

FIG. 6 is a cross-sectional view showing the connection structure of the rechargeable battery device.

FIG. 7 is a perspective view showing part of the assembling process of the rechargeable battery.

### DETAILED DESCRIPTION

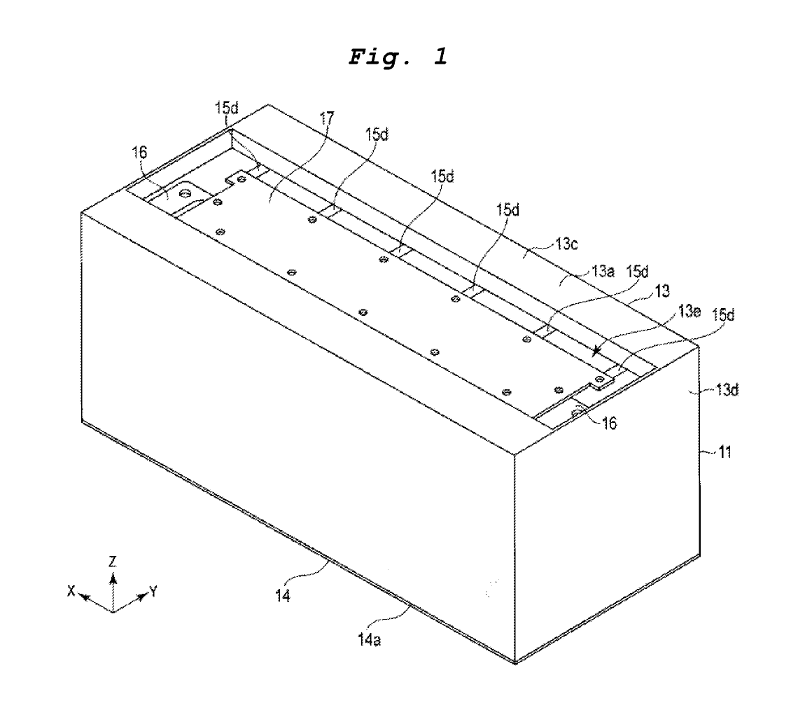

In general, according to one embodiment, a rechargeable battery device according to an embodiment will be explained by referring to FIG. 1 to FIG. 7. In each figure, direction arrows X, Y, and Z show three mutually orthogonal directions. Furthermore, in each diagram, appropriate parts of the rechargeable battery is expanded, reduced or omitted for purpose of illustration.

A battery according to one embodiment includes a plurality of electrode members having a positive electrode plate, a negative electrode plate, and an insulating separator placed between the positive electrode plate and the negative electrode plate, a first case made of resin, in which a plurality of leads connected electrically to each of the plurality of electrode members and bus bars having a plurality of terminals to be connected electrically to each of the plural leads are integrated, and a battery case housing the plural electrode members therein.

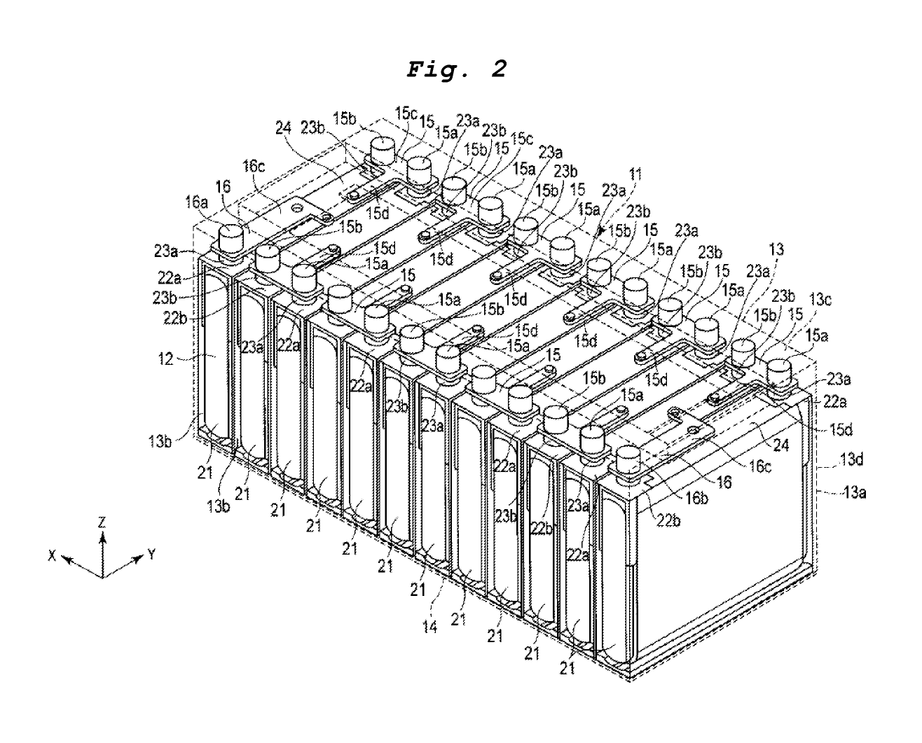

FIG. 1 is a perspective view showing the external appearance of a rechargeable battery device 1 according to an embodiment, and FIG. 2 is a perspective view showing its internal structure. The rechargeable battery device 1 shown in FIG. 1 and FIG. 2 is composed of a battery case 11 with a housing part 11a (see FIG. 7) which is a space formed by dividing the inner part of the battery case 11 in plural numbers, plural electrode groups 12 housed together with a non-aqueous electrolytic solution in the battery case 11, and a battery set that is made up of plural rechargeable battery units, each of which functions as a rechargeable battery.

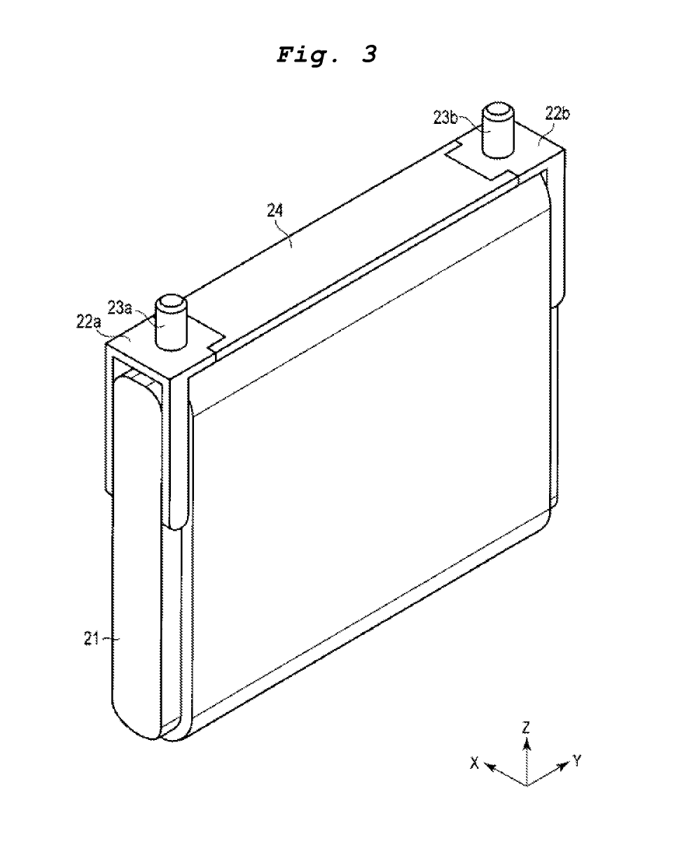

Furthermore, in the embodiment, each of the electrode groups 12 is composed of electrode members including a positive electrode plate, a negative electrode plate, an insulating separator placed therebetween, and leads which are connected electrically to each of the positive electrode plate and the negative electrode plate (for example, positive electrode lead 22a and negative electrode 22b in FIG. 3).

The battery case 11 has a first case 13 and a second case 14, and has a rectangular box form. The first case 13 and the second case 14 are sealed to form a sealed space in the battery case 11, in which a non-aqueous electrolytic solution and plural electrode groups 12 are housed.

As resin materials to be used in the first case 13 and the second case 14, thermoplastic resins (non-crystalline) are preferred, for example, modified PPE (polyphenylene ether).

The first case 13 has a “basket” form, and many partitioning plates are placed therein. More specifically, the first case 13 is equipped with an outer part (basket body) 13a, which has a bottom-opened rectangular box form, and plural partitioning plates 13b, which are arranged in parallel within the outer part 13a. The outer part 13a has a ceiling wall 13c, which covers one side of the electrode group 12, and side walls 13d, which cover the circumference, and has an opening at the bottom side. In the ceiling wall 13c, plural bus bars 15 are integrated therein by insert molding. The outer part 13a carries out a function of preventing short-circuit between terminals by electrical insulation

A substrate housing part 13e is formed on the outer surface side of the ceiling part 13d, on which a circuit substrate 17 for voltage detection is arranged. The substrate housing part 13e has a concavity at its upper side with a fixed width along the longitudinal direction (X direction) in the central part of the battery case 11.

In the substrate housing part 13e, voltage detection terminals 15d being constituted as a part of bus bar 15 and outer output terminal 16, which is connected individually to positive electrode lead 22a of the electrode group 12 at one end of the array and negative electrode lead 22b of the electrode group 12 at the other end of the array, are exposed to the outer side of the first case 13.

The partition plates 13b are arranged in parallel so as to partition the inner space of the outer part 13a a plural number of times in the X direction and to form in parallel plural housing compartments 11a (see FIG. 7) each having a form corresponding to the shape of the electrode group 12. In the embodiment, 11 units of partition plates 13b are formed in parallel along the X direction, and 12 units of housing compartment 11a are formed in parallel in the X direction. The partition plate 13b carries out a position-locating function of electrode group 12 and prevents short-circuit between the electrode groups 12.

Each of the housing compartments 11a has a narrow and long rectangular shape corresponding to the shape of the electrode group 12 housed therein. Each electrode group 12 is housed to extend along the width direction (Y direction) of the battery case 11 so that plural electrode groups 12 are arranged in parallel along the longitudinal direction (X direction) of the battery case 11.

In the ceiling wall 13c, plural bus bars 15 and exterior output terminals 16 are integrally molded by inserting molding. Here, 11 units of bus bars 15 are arranged in parallel at a predetermined position so as to connect serially adjacent 12 units of electrodes in the electrode groups 12, and exterior output terminals 16 are arranged at both ends of the array. In such a manner, plural bus bars 15 and exterior output terminals 16 are formed integrally in the first case 13. One part of plural bus bars 15 and exterior output terminals 16 is exposed to the outside of the first case 13, and another part thereof is within the first case 13.

Besides, in the ceiling wall 13c, gas-discharging valves or liquid-injecting holes are formed. When gas is generated inside the case by abnormal operation and the like, and the internal pressure rises above the predetermined value, gas is released through the valves. This lowers the internal pressure and prevents failure such as rupture and the like.

In the present embodiment, as mentioned above, each electrode group 12 is composed of electrode members each having a positive electrode plate, a negative electrode plate and an insulating separator formed therebetween, and leads for electrically connecting each positive electrode plate and negative electrode plate of the electrode member. As shown in FIG. 3 as an example, the composition of electrode group 12 refers to the positive electrode lead 22a and negative electrode lead 22b. As shown in FIG. 3, the electrode group 12 is provided with coil 21 obtained by winding the positive electrode plate and the negative electrode plate and making them into a flat shape, positive electrode lead 22a and negative electrode lead 22b which are pulled out at both sides of the coil 21.

The coil 21 is formed by winding spirally a positive electrode plate, a negative electrode plate, and an insulating separator placed there-between and compressing along the diameter direction to make it into a rectangular flat form.

The positive electrode lead 22a and negative electrode lead 22b are extended toward an upper part higher than the coil 21 to have a plate form that is bent toward the inner side. A cap 24 is formed between the positive electrode lead 22a and the negative electrode lead 22b. The cap 24 is formed from insulating resin and the like in a plate form, and it is formed by inserting it between positive electrode lead 22a and negative electrode lead 22b so that the distance between the positive electrode lead 22a and the negative electrode lead 22b is regulated to control the positions of the positive electrode lead 22a and the negative electrode lead 22b. By the control function of the cap 24, a pair of positive electrode leads 22a and negative electrode lead 22b can be connected with high accuracy to their respective terminals, 15a and 15b.

Positive electrode connector 23a and negative electrode connector 23b are inserted into holes 15e of bus bar 15 to connect the terminal 15a and the terminal 15b respectively to the positive electrode lead 22a and negative electrode lead 22b.

Plural electrode groups 12 are arranged so as to stand alternate between positive electrode connector 23a and negative electrode connector 23b of adjoining electrode groups 12. Plural electrode groups 12 are electrically connected serially by plural bus bars 15 as conductive material.

Exterior output terminals 16 are connected respectively to the negative electrode connector 23b of the electrode group 12 positioned at one end of the array among plural electrode groups 12 and the positive electrode connector 23a of the electrode groups 12 positioned at the other end of the array.

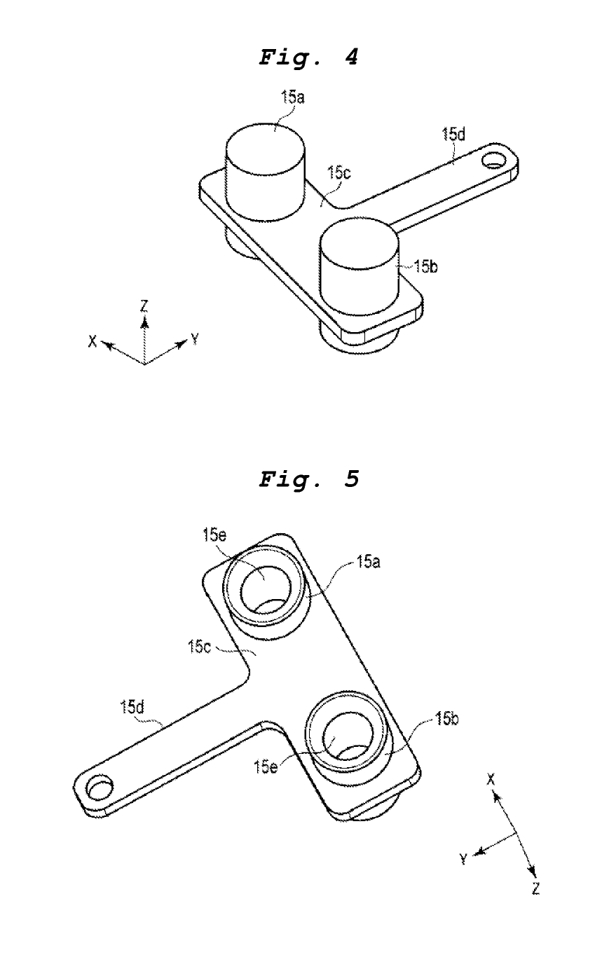

Each of plural bus bars 15, shown in FIG. 1, FIG. 2, FIG. 4, and FIG. 5, is made from conductive materials such as metallic materials, e.g. aluminum, copper, bronze and the like, and includes the terminals 15a, 15b, connection plate 15c for connecting them, and the voltage detection terminal 15d as one integrated single body.

Here, bus bar 15 has a T-shape, and has a pair of cylindrical terminals 15a, 15b connected to each other integrally, and a part of the middle of terminals 15a, 15b extended towards the central part in the width direction (arrow direction Y) to function as a voltage detection terminal 15d.

The terminal 15a at one side is connected to positive electrode connector 23a of an electrode group 12 while the terminal 15b at the other side is connected to negative electrode connector 23b of an adjacent electrode group 12, and those electrode terminals are connected electrically. Twelve units of electrode group 12 are connected serially by plural bus bars 15 in the same manner as described above. Alternatively, plural electrode groups 12 may be connected in parallel.

Each of the terminals 15a, 15b is composed of, for example, the form of cylinder having a bottom, and a hole 15e, which extends in the Z direction, is formed at the center of the bottom.

One end of terminals 15a, 15b is projected to the inner side of ceiling 13a of the first case 13. The terminals 15a, 15b are joined to the first case 13 by insert molding and buried therein as an integrated member. The voltage detection terminal 15d is exposed to the outside from the concave part 13e of the first case 13.

Each of the terminals 15a and 15b of bus bar 15 is arranged to correspond to each of positive electrode lead 22a and negative electrode lead 22b, and each electrode group 12 is located in a corresponding housing compartment 11a of the first case 13, while positive electrode connector 23a and negative electrode connector 23b, which correspond to positive electrode lead 22a and negative electrode lead 22b of electrode group 12, respectively, are inserted into holes 15e of the terminals 15a and 15b.

With the configuration described above, positive electrode connector 23a and negative electrode connector 23b of adjacent electrode groups 12 are electrically connected to each other through connector 15c and terminal 15a, 15a of bus bar 15.

Exterior output terminal 16 has a terminal 16a or 16b composed of cylindrical part with a hollow insertion part (hole) at the bottom thereof and a plate-form voltage detection terminal 16c, which extends from a center portion of the terminal 16a or 16b, and they are formed integrally as one body from conductive materials such as metallic materials, e.g., aluminum, copper, bronze, gold and the like.

The terminal 16a or 16b of the exterior output terminal 16 is arranged to correspond to negative electrode connector 23b of electrode group 12 positioned at one end of the array of electrode groups 12 and positive electrode connector 23a of electrode group 12 positioned at the other end of the array. The position of electrode group 12 is determined in housing compartment 11a of the first case 13 while positive electrode connector 23a and negative electrode connector 23b are inserted, respectively, into the holes of the terminal 16a or 16b.

A circuit board 17, which includes a voltage control unit, a voltage detection unit, and a temperature sensor or the like, is formed in the substrate housing part 13e that is at the outer surface side of the first case 13, and connected electrically to the voltage detection terminal 15b, 16c exposed to the outside of substrate housing part 13e.

The second case 14 is provided with plate-form bottom wall 14a closing up the bottom opening of the first case 13.

The top surface of bottom wall 14a is provided with curved surfaces, which are curved along the shape of electrode group 12 and arranged in parallel. After housing the electrode group 12, the second case 14 is assembled to the first case 13 in a manner of closing up the bottom opening so that the housing compartment 11a is closed up.

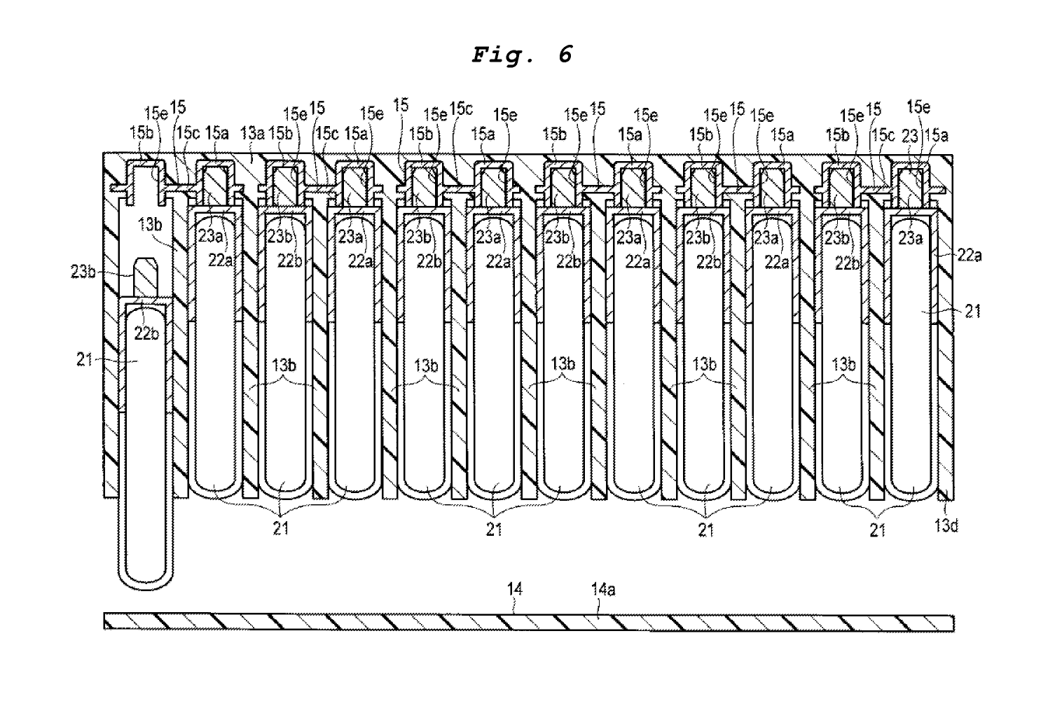

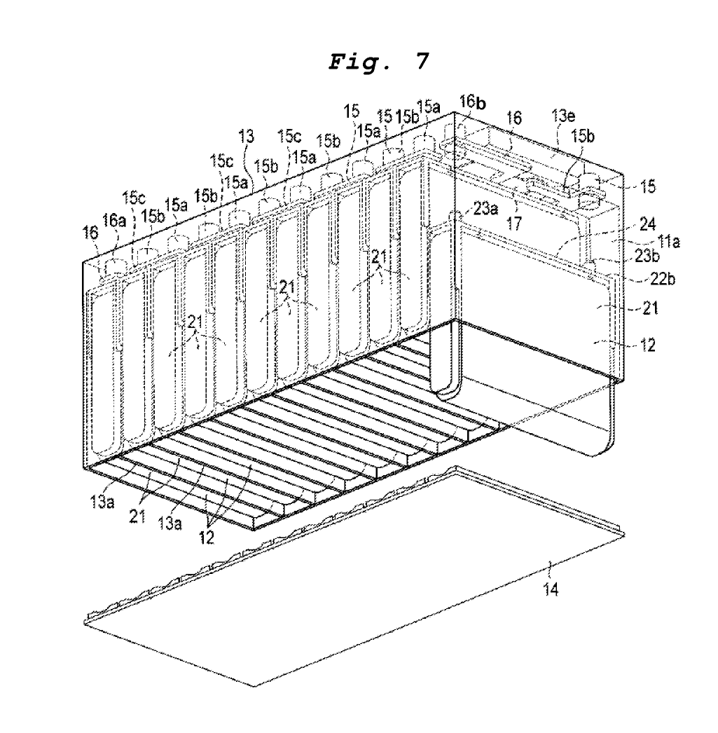

Hereinafter, the method of assembling batteries according the present embodiment is explained by referring to FIG. 6 and FIG. 7. In terms of the assembling process, as shown in FIG. 6 and FIG. 7, first, electrode group 12 is arranged in the first case 13 by inserting individual electrode group 12 into each housing compartment 11a of the first case 13 through the bottom opening.

As described above, the first case 13 is a resin molded article and has a basket form. In the first case 13, each of the electrode groups 12 is arranged in the compartment 11a of the battery case 11 so that positive electrode connector 23a and negative electrode connector 23b corresponding to positive electrode lead 22a and negative electrode lead 22b of adjacent electrode groups 12, respectively, are inserted into respective holes 15e of the terminals 15a and 15b that are connected by connection part 15c. In the first case 13, positive electrode connector 23a and negative electrode connector 23b, which are connected to positive electrode lead 22a and negative electrode lead 22b, respectively, are electrically connected by bus bar 15. Furthermore, positive electrode connector 23a and negative electrode connector 23b of electrode group 12 at both ends of array are inserted into respective hole of exterior output terminals 16 and joined by electrical connection and physical joining.

As shown in FIG. 7, the second case 14 is assembled at the arranged state of all electrode groups 12 so as to close up the bottom opening of the first case 13. Thus, electrode group 12 is housed in compartment 11a and sealed.

Then, circuit board 17 is arranged in substrate housing part 13e so as to connect to voltage detection terminals 15d, 16c which are exposed to the outer surface of the first case 13.

Furthermore, various treatments such as electrolytic solution treatment, initial charging and discharging, and the like are carried out in order to complete the rechargeable battery device 10 as a battery set.

The following effect is achieved by the rechargeable battery device and the method of assembling a rechargeable battery device according to this embodiment. Namely, since bus bar 15 is integrated into the resin-made battery case 11, the assembling process can be simplified and also the problems in the installation process of bus bar 15 can be reduced so that the loss of product yield can be reduced.

Electrode group 12 with coil 21, positive electrode lead 22a, and negative electrode lead 22b is arranged in the compartment 11a in the battery case 11, positive electrode connector 23a and negative electrode connector 23b, which correspond to positive electrode lead 22a and negative electrode lead 22b of the electrode group 12, respectively, are inserted into a hole 15e of bus bar 15 simultaneously at the time of assembling of battery case 11. Therefore, number of assembling parts can be reduced and assembling process can be simplified with preservation of high accuracy.

Furthermore, in the embodiment, a case of arranging plural electrode groups 12, for example, in a row and connecting them electrically in series is explained, but the present invention is not limited to this. The present invention can be applied to cases where the plural electrode groups 12 are connected in parallel. Even in such cases, electrical connection of leads and bus bars can be easily carried out during the assembling of electrode groups into the case since bus bars are integrated in the resin-made case.

In the embodiment, partition plate 13b is integrated at the side of the first case 13 and plural housing compartments 11a are produced, but it is limited to this case only. For example, it can be composed by separating the ceiling 13a and the side part 13c and making a third case with side part 13c and partition plate 13b as a separate structure. Even such a case, bus bar 15 is insert-molded integrally in ceiling 13a so that same effect of the embodiment is obtained.

Various materials besides the modified PPE can be used as resins for the first case 13 and the second case 14. For example, olefin resins such as PE, PP, PMP and the like, polyester resins such as PET, PBT, PEN and the like, POM resin, polyamide resins such as PA6, PA66, PA12 and the like, crystalline resins such as PPS resin, LCP resin and the like, and their alloy resins, non-crystalline resins such as PS, PC, PC/ABS, ABS, AS, PES, PEI, PSF and the like, and their alloy resin can be used. In addition, positive electrode material and negative electrode material of coil 21, and materials for terminal 15 can be modified according to the aforementioned materials.

While certain embodiments have been described, these embodiments have been presented as examples only, and are not intended to limit the scope of the inventions. In fact, the novel embodiments described herein maybe embodied in a variety of other forms; furthermore, various omissions, substitutions and changes of the embodiments described herein can be made without departing from the spirit of the inventions. The claims described below and their equivalents are intended to cover such forms or modifications as would fall within the scope and spirit of the inventions.

What is claimed is:

1. A battery comprising:
a plurality of electrode members each including a positive electrode, a negative electrode and an insulating separator arranged between the positive electrode and the negative electrode;
a plurality of bus bars each electrically connecting electrode members; and
a battery case in which the plurality of electrode members are housed, the battery case including a portion made of resin in which the bus bars are arranged at predetermined positions relative to each other.

2. The battery according to claim 1, wherein
each of the bus bars has terminals formed thereon, and
connectors projecting from each of the positive and negative electrodes are each electrically connected to one of the terminals.

3. The battery according to claim 2, wherein
the terminals each have a hole formed therein into which a corresponding connector is inserted.

4. The battery according to claim 2, wherein each of the bus bars has a connector section extending between the terminals, and the connector section electrically connects a positive terminal electrically connected to one of the adjacent electrode members to a negative terminal electrically connected to a different one of the adjacent electrode members.

5. The battery according to claim 4, wherein each of the bus bars includes a voltage detection terminal that is electrically connected between the terminals thereof.

6. The battery according to claim 1, wherein the bus bars are integrated into the portion by molding.

7. The battery according to claim 6, wherein the voltage detection terminal is exposed to an exterior of the battery case.

8. The battery according to claim 7, wherein the battery case has a recessed portion and the voltage detection terminals are exposed through the recessed portion.

9. The battery according to claim 1, wherein the battery case includes a partition plate to form a plurality of compartments in an interior thereof, each of the electrode members being housed in one of the compartments.

10. The battery according to claim 9, wherein the battery case includes a cover that seals the compartments.

11. A method for assembling a battery including
bus bars in a case made of resin, the method comprising:
electrically connecting plural electrode members each having a positive electrode, a negative electrode, and an insulating separator arranged therebetween to the bus bars, such that each of the bus bars is electrically connected to two electrode members.

12. The method according to claim 11, wherein
the electrode members have connectors which project from the positive and negative electrodes and the bus bars each have positive and negative terminals formed with holes therein into which the connectors of the electrode members are inserted.

13. The method according to claim 12, wherein each of the bus bars includes a voltage detection terminal that is electrically connected between the terminals thereof, and is exposed to an exterior of the case.

14. The method according to claim 13, wherein the case includes a partition plate to form a plurality of compartments in an interior thereof, each of the electrode members being housed in one of the compartments.

15. The battery according to claim 14, wherein the case includes a cover that seals the compartments.

16. A method for assembling a battery comprising:
partitioning a case to have a plurality of interior compartments;
arranging plural electrode members in the interior compartments, each of the electrode members having a positive electrode, a negative electrode, and an insulating separator arranged therebetween;
electrically connecting the positive electrodes and the negative electrodes of the electrode members to bus bars formed in the case; and
closing up the interior compartments in which the electrode members are arranged.

17. The method according to claim 16, wherein
the electrode members have connectors which project from the positive and negative electrodes and the bus bars each have a terminal formed with holes therein into which the connectors of the electrode members are inserted.

18. The method according to claim 17, wherein each of the bus bars includes a voltage detection terminal that is electrically connected between the terminals thereof, and is exposed to an exterior of the case.

19. The method according to claim 18, wherein the case is partitioned by inserting a partition plate.

20. The method according to claim 16, wherein such each of the bus bars is electrically connected to two electrode members.
